(19) United States
(12) Patent Application Publication
(10) Pub. No.: US 2011/0099911 A1
(43) Pub. Date: May 5, 2011

(54) DOOR STRUCTURE WITH CO-EXTRUDED ROLL FRAME

(76) Inventors: Peter John Ellis, Rochester Hills, MI (US); Haruhisa Kawase, Rochester Hills, MI (US)

(21) Appl. No.: 12/936,405

(22) PCT Filed: Apr. 3, 2009
(86) PCT No.: PCT/CA09/00437

§ 371 Date: Jan. 17, 2011

Related U.S. Application Data
(60) Provisional application No. 61/123,767, filed on Apr. 11, 2008.

(51) Int. Cl. B60J 5/04; B60J 10/04

(52) U.S. Cl. 49/493.1; 49/475.1

(57) ABSTRACT

A motor vehicle door includes a door frame including a main body portion having a retention wall. An upper reveal fixedly secured to the door frame and includes an outer wall. The outer wall of the upper reveal and the retention wall of the door frame define a channel therebetween. Each of the outer wall and the retention wall engage a glass run to retain the glass nm within the channel.

### BACKGROUND

1. Field of the Invention

The invention relates to upper reveals for motor vehicle door frames. More particularly, the invention relates to an upper reveal that is secured to a motor vehicle door frame and cooperates therewith to retain a glass run.

2. Description of Related Art

A typical upper reveal utilized in a motor vehicle door frame includes a separate retainer for fixing a glass run in place. The inclusion of the separate retainer results, however, in a door that is heavier in weight and more expensive to produce. In another common configuration, a molding that is utilized with the upper reveal and the door frame has a large seal profile which makes installation to the door frame difficult. Such large seals are also more expensive to produce.

### SUMMARY

According to one aspect of the invention, a motor vehicle door includes a door frame including a main body portion having a retention wall. An upper reveal is fixedly secured to the door frame and includes an outer wall. The outer wall of the upper reveal and the retention wall of the door frame define a channel therebetween. Each of the outer wall and the retention wall engage a glass run to retain the glass run within the channel.

According to another aspect of the invention, a motor vehicle door includes a door frame including a main body portion having a retention wall defining a pocket. An upper reveal is fixedly secured to the door frame and includes an outer wall. The outer wall of the upper reveal and the retention wall of the door frame define a channel therebetween. A glass run is disposed within the channel and is retained therein by abutting engagement with each of the outer wall and the pocket of the retention wall.

According to yet another aspect of the invention, a glass run retention assembly is provided for a motor vehicle door frame including a main body portion having a retention wall. The glass run retention assembly includes an upper reveal having a mounting segment adapted to be fixedly secured to the door frame. The upper reveal includes an outer wall coupled to the mounting segment and extending out therefrom. The outer wall cooperates with the retention wall to define a channel therebetween for receiving a glass run within the channel. An interior trim has an upper end adapted to be fixedly secured to the main body portion and a lower end adapted to be fixedly secured to the retention wall. The lower end of the interior trim engages the glass run to retain the glass run within the channel.

### BRIEF DESCRIPTION OF THE DRAWINGS

The invention will be readily appreciated as the same becomes better understood by reference to the following detailed description when considered in connection with the accompanying drawings wherein:

FIG. 1 is a cross-sectional view of a door frame including an upper reveal secured thereto according to one embodiment of the invention;

FIG. 2 is a cross-sectional view of an alternative door frame including the upper reveal secured thereto;

FIG. 3 is a cross-sectional view of the upper reveal; and

FIG. 4 is a cross-sectional view of a door frame and upper reveal according to another embodiment in which an interior trim piece cooperates with the upper reveal to retain a glass run.

### DETAILED DESCRIPTION OF THE EMBODIMENTS

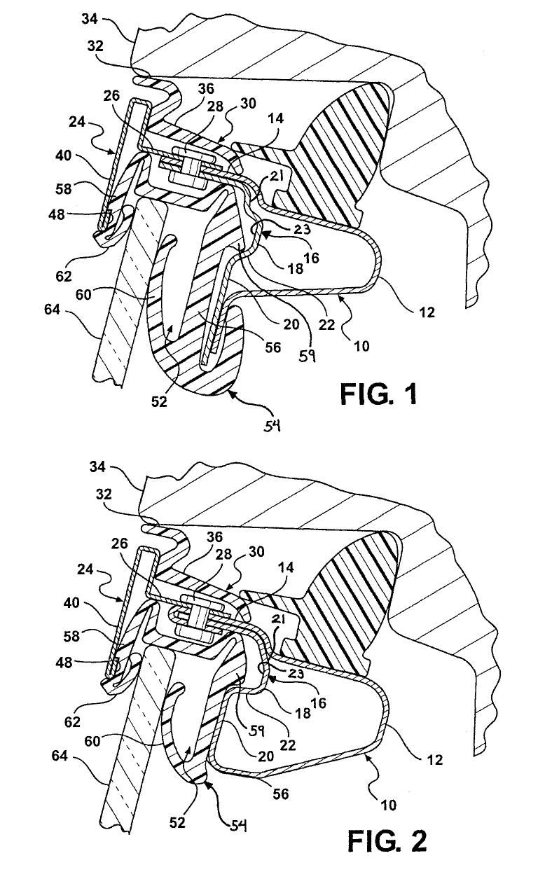

Referring to FIGS. 1 and 2, a door frame, generally indicated at 10, for a motor vehicle door includes a body portion 12 and a flange 14 extending out therefrom. The body portion 12 includes a retention wall, generally indicated at 16, having an upper segment 18 and a lower segment 20. The upper 18 and lower 20 segments are offset from one another by a connecting segment 22. The retention wall 16 further includes an end segment 21 offset from the upper segment 18 to connect the upper segment 18 to the flange 14. A pocket 23 is formed by the positioning of the upper segment 18 offset from the connecting segment 22 and the end segment 21. The door frame 10 may be a stamped sheet metal door frame, as shown in FIG. 1, or a roll formed door frame, as shown in FIG. 2.

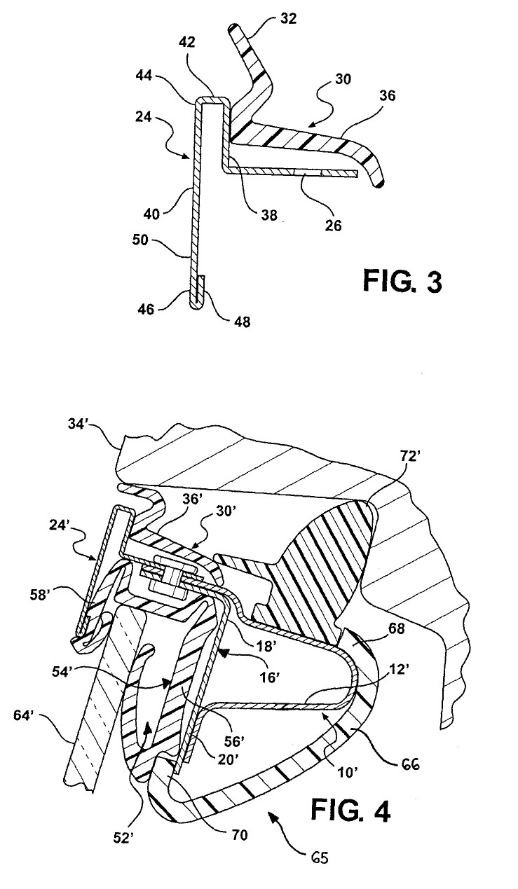

Referring to FIGS. 1 through 3, an upper reveal, generally indicated at 24, is adapted to be fixedly secured to the door frame 10. The upper reveal 24 includes a mounting segment 26. The mounting segment 26 is generally horizontal and may be shaped to complement the flange 14. To fixedly secure the upper reveal 24 to the door frame 10, the mounting segment 26 is placed on top of the flange 14. A rivet 28 extends through the mounting segment 26 and the flange 14 to fixedly mount the upper reveal 24 to the door frame 10.

An upper molding, generally indicated at 30, is co-extruded with the upper reveal 24. The upper molding 30 includes a sealing lip 32 for sealing engagement with a motor vehicle body 34. The upper molding 30 also includes a closeout lip 36 that covers the rivet 28 to hide the rivet 28 from view. The upper molding 30 may be formed from a thermoplastic vulcanizate (TPV), polyvinyl chloride (PVC), EPDM, or a like material.

The upper reveal 24 also includes an inner wall 38 and an outer wall 40 connected to one another by a top segment 42. The outer wall 40 extends between an upper end 44 and an opposing lower end 46. The outer wall 40 includes a retaining tab 48 formed at the lower end 46. The outer wall 40 also includes a reveal surface 50 extending along the outer wall 40 between the upper 44 and lower 46 ends. The reveal surface 50 is visible along a door exterior when the upper reveal 24 is mounted to the door frame 10.

Upon installation of the upper reveal 24 to the door frame 10, the outer wall 40 of the upper reveal 24 and the retention wall 16 of the door frame 10 cooperate to define a channel 52 therebetween. A glass run, generally indicated at 54, is received within the channel 52 and includes spaced apart first 56 and second 58 walls. The glass run 54 includes a protrusion 59 formed along and extending out from the first wall 56. The glass run 54 also includes sealing members 60, 62 for sealing engagement with a window pane 64. The connecting segment 22 of the door frame 10 engages the protrusion 59 formed along the first wall 56 of the glass run 54 and maintains a portion thereof in the pocket 23, and the retaining tab 48 of the upper reveal 24 engages the second wall 58 of the glass run 54 to securely retain the glass run 54 within the channel 52. Thus, the door frame 10 and the upper reveal 24 hold the glass run 54 in place without the need for an additional glass run retention structure. In addition, the upper reveal 24 and the door frame 10 have a low profile due to the configuration of the co-extruded upper molding 30.

Referring to FIG. 4, in an alternative embodiment of the invention, a glass run retention assembly 65 includes an interior trim 66 disposed along the body portion 12′ of the door frame 10′ and secured thereto by clips (not shown). The interior trim 66 extends between an upper end 68 and a lower end 70. The upper end 68 of the interior trim 66 abuts a seal 72. The lower end 70 of the interior trim 66 is disposed alongside the retention wall 16′. In the current embodiment, the upper 18′ and lower 20′ segments of the retention wall 16′ are not offset by a connecting wall. Instead, the lower end 70 of the interior trim 66 engages the first wall 56′ of the glass run 54′. The glass run retention assembly 65 includes the upper reveal 24′ which cooperates with the interior trim 66 to retain the glass run 54′ in place within the channel 52′. The interior trim 66 is formed from polypropylene or a similar material.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A motor vehicle door comprising:
a door frame including a main body portion having a retention wall; and
an upper reveal fixedly secured to said door frame and including an outer wall, said outer wall of said upper reveal and said retention wall of said door frame defining a channel therebetween, each of said outer wall and said retention wall engaging a glass run to retain the glass run within said channel.

2. A motor vehicle door as set forth in claim 1 wherein said outer wall of said upper reveal includes a retaining tab engageable with the glass run to retain the glass run within said channel.

3. A motor vehicle door as set forth in claim 2 including an upper molding co-extruded with said upper reveal and including a sealing lip for sealing engagement with a motor vehicle body.

4. A motor vehicle door as set forth in claim 3 wherein said outer wall of said upper reveal defines a reveal surface visible along a door exterior.

5. A motor vehicle door as set forth in claim 1 wherein said retention wall of said door frame includes upper and lower segments offset from one another by a connecting segment.

6. A motor vehicle door as set forth in claim 5 wherein said upper segment and said connecting segment define a pocket for receiving a portion of the glass run.

7. A motor vehicle door as set forth in claim 6 wherein said door frame includes a flange extending out from said body portion.

8. A motor vehicle door as set forth in claim 7 wherein said upper reveal includes a mounting segment abutting said flange of said door frame for attachment thereto.

9. A glass run retention assembly for a motor vehicle door frame including a main body portion having a retention wall, said glass run retention assembly comprising:
an upper reveal including a mounting segment adapted to be fixedly secured to the door frame, said upper reveal including an outer wall coupled to said mounting segment and extending out therefrom, said outer wall cooperating with the retention wall to define a channel therebetween for receiving a glass run within said channel; and
an interior trim having an upper end adapted to be fixedly secured to the main body portion and a lower end adapted to be fixedly secured to the retention wall, said lower end of said interior trim engaging the glass run to retain the glass run within said channel.

10. A motor vehicle door as set forth in claim 9 wherein said outer wall of said upper reveal includes a retaining tab engageable with the glass run to retain the glass run within said channel.

11. A motor vehicle door as set forth in claim 10 including an upper molding co-extruded with said upper reveal and including a sealing lip for sealing engagement with a motor vehicle body.

12. A motor vehicle door as set forth in claim 11 wherein said outer wall of said upper reveal defines a reveal surface visible along a door exterior.

13. A motor vehicle door comprising:
a door frame including a main body portion having a retention wall defining a pocket;
an upper reveal fixedly secured to said door frame and including an outer wall, said outer wall of said upper reveal and said retention wall of said door frame defining a channel therebetween; and
a glass run disposed within said channel and retained therein by abutting engagement with each of said outer wall and said pocket of said retention wall.

14. A motor vehicle door as set forth in claim 13 wherein said glass run includes spaced apart first and second walls, said first wall including a protrusion abutting said pocket to retain said glass run between said door frame and said upper reveal.
